(19) United States
(12) Patent Application Publication
(10) Pub. No.: US 2006/0175166 A1
(43) Pub. Date: Aug. 10, 2006

(54) Controllable piston valve and /or flat valve for a vibration damper

(75) Inventor: Jurgen Fischer, Pinneberg (DE)

Correspondence Address: WALL MARJAMA & BILINSKI, 101 SOUTH SALINA STREET, SUITE 400, SYRACUSE, NY, 13202, US

(73) Assignee: TUHH Technologie gmbH, Hamburg (DE)

(21) Appl. No.: 10/524,437

(22) PCT Filed: Aug. 12, 2002
(86) PCT No.: PCT/EP03/08953

§ 371 Date: Aug. 2, 2005

(30) Foreign Application Priority Data
Aug. 13, 2002 (DE) 10236963.1

(51) Int. Cl. F16F 9/34

(52) U.S. Cl. 188/322.13

(57) ABSTRACT

A controllable piston valve for a shock absorber in a piston cylinder structure includes a piston valve member controlling a throughflow area is actuated by a differential control piston. Oppositely directed effective surfaces of the control piston are subject to the pressure of the piston chamber and the annular chamber of the cylinder. The control piston and/or the piston valve member are additionally loaded with a pressure of a pressure source opposite to the larger of the effective surfaces, the pressure source being formed by a combination of a fluidic resistance and a fluidic capacitance and are supplied by the pressure in the piston chamber or the annular chamber of the piston cylinder structure.

The invention refers to a controllable piston valve and/or controllable bottom valve according to the patent claims 1, 2 and 5.

If hereinafter it is spoken of a piston valve, then a valve arrangement in a piston of a shock absorber having a piston cylinder structure is meant or an external valve as well which interconnects the piston chamber and the annular chamber of a piston cylinder structure.

### BACKGROUND OF THE INVENTION

Shock absorbers, in particular for automobiles as known consist of a parallel or series arrangement of a damping member and a spring member. Under damping members in form of a piston cylinder structure one differentiates generally between one-tube and double-tube absorbers. In one-tube absorbers a valve arrangement is provided in the piston of the piston cylinder structure which restricts the fluid in both directions of its throughflow passage, and in the piston chamber a separate storage volume is located which is compressed in the pressure cycle of the shock absorber. In double-tube absorbers the storage volume is formed in an intermediate space between an inner and an outer chamber, and the connection between these chambers takes place through a so-called bottom valve. The bottom valve for example is effective in the pressure cycle in that it restricts the flow of the damping medium into the storage while in the pulling cycle for example a low resistance flow from the storage into the piston chamber takes place and a throttling effect in a valve arrangement in the piston of the piston damper arrangement as well. A bottom valve is also used in a damping member in a plunger cylinder arrangement wherein the damping medium in the compression cycle is pressed into an external storage through a bottom valve while in the pulling cycle the medium flows back from the external storage into the plunger chamber through the bottom valve. In spite of a plunger a piston can be used with the annular chamber of the cylinder is open to atmosphere.

In automobiles the damping behaviour of a shock absorber influences the driving comfort as well as the safety, in particular when driving curves. However, there is a conflict between both desired properties. If the shock absorber is dimensioned for maximum safety the comfort suffers because the shock absorber reacts hard. If, however, the comfort is preferred the safety suffers for soft damping behaviour. Therefore, it is a task for the designer to select the characteristic curve such that in view of safety and driving comfort a compromise is achieved.

It is known to dimension piston valves and/or bottom valves for shock absorbers such that the throughflow area is changed in operation. In this connection it is also known to control the throughflow area in response to the pressure relation between the piston chamber and the annular chamber. As known a shock absorber has the task to counter-effect the acceleration of a mass, e.g. the body of a vehicle. The control of the throughflow area in dependence of the pressure difference in the piston cylinder arrangement can solve this problem only partially because the effect of the spring force is not considered.

It is also known to measure the performance of a vehicle in particular the acceleration in vertical and transverse direction by means of sensors and to derive therefrom control signals for the shock absorber in order to optimize driving comfort and safety. Such shock absorbers and the necessary control components, respectively, are extremely expensive and subject to interferences. Furthermore, such control system has a relatively small natural frequency.

### SUMMARY OF THE INVENTION

It is an object of the invention to provide a piston valve or a bottom valve, respectively, for a shock absorber wherein the throughflow area can be easily changed in response to the acceleration of the mass.

In the piston valve of patent claim 1 a piston valve member controlling the throughflow area is defined by a control piston designed as differential piston having opposing effective surfaces which are supplied with the differential pressure of the piston chamber and the annular chamber in the cylinder. The control piston is additionally loaded by the pressure of a pressure source (compensation or balancing pressure source) opposite to the larger of the effective surfaces, the pressure source being formed by a combination of a fluidic resistance and a fluidic capacitance which are supplied by the pressure in the piston chamber or annular chamber of the cylinder. The invention preferably is used in connection with hydraulic applications, however, also a pneumatic application is also pregnant and practical. Therefore, frequently the term “fluid” and “fluidic” is used to cover both forms of an application.

The described piston valve is controlled by a control piston in both directions. In spite of a differential piston two control pistons each having two effective surfaces can be used each actuating a valve member. It is also possible to provide a valve member for each direction of throughflow each being actuated by a differential control piston.

Alternatively, a second piston valve member can be arranged parallel to the described first piston valve member which is also actuated by a differential piston having oppositely directed effective surfaces. The flow of the damping medium is divided into two flows while one throughflow area considers the pressure difference and the piston of the shock absorber and the other reflects the spring member.

If in the above and here below it is spoken of a piston valve or a piston valve spool, this should also include valves and spools which cooperate with different valve members and actuators, e.g. rotary slides or the like.

According to an embodiment of the invention the valve according to the invention can be formed by a two-way acting valve having an integral valve member which includes two control surfaces or control edges, respectively, with the piston valve member being subject to the pressure of a compensation pressure source. The integral valve member or valve spool can be replaced by two single valve members for a flow in both directions. For the actuation a smooth cylindrical control piston can be used, with the effective surfaces of a control piston being connected to the piston chamber and the annular chamber respectively. The effective surfaces of the other control piston are connected with the piston chamber and the compensation pressure source. The effect of the first valve member on the throughflow area corresponds to the damper force and that of the second valve member to that of the spring force. Owing to the simple piston or valve member this embodiment is particularly inexpensive under technical aspects.

It is essential to the invention that with such a piston valve the throughflow area is controlled in dependence of each acceleration of the mass. The described effective surfaces on the control piston are dimensioned such that the damper force of the absorber member on the one side and the force of the damper spring arrangement on the other side are adequately considered.

Since the valve member or the integral valve member, respectively, of the piston valve according to the invention have very small sizes and a small mass, it is possible to realize high frequencies for the control of the throughflow area by the control according to the invention. This is in contrast to electronic solutions which are forced to work with low frequency ranges.

The pressure source formed of a fluidic capacitance and a fluidic resistance defines a sort of filter section which smoothes or reduces pressure variations of the oil flow. To provide a fluidic resistance, a small orifice can be used and as a fluidic capacitance a fluid accumulator which may be separated from a pressurized air volume by a diaphragm.

The controllable bottom valve of patent claim 5 includes a bottom valve member controlling the throughflow area, with the valve member being actuated by a control piston formed as differential piston. The differential piston has a first effective surface which is subject to the pressure in the piston chamber or the plunger chamber, respectively of a piston cylinder structure. A second effective surface having the same direction as the first effective surface is subject to the pressure of the storage volume, the storage volume being supplied with the damping medium of the piston chamber through the bottom valve. A third effective surface opposite to the first and second effective surface is subject to the pressure of a compensation pressure source which is defined by combination of a fluidic resistance and a fluidic capacitance. This compensation source is supplied either by the pressure in the piston chamber or the storage volume.

For the bottom valve with the above features the same is valid as outlined to the already mentioned piston valve. It is in a position to adjust the throughflow area in response to the acceleration of the mass. The dimensioning of the effective surfaces considers the influence of the damper spring and of the damping member in form of a piston cylinder or plunger cylinder arrangement, respectively.

With the bottom valve described an acceleration depending throttling of the damping medium can be achieved in one direction. In the opposite direction a conventional valve can be used or also a check valve. This depends on the design of the piston valve which is considered in more detail below. It may, however, be appropriate to provide the bottom valve with an integral valve member or spool which includes two control surfaces or control edges to control the throughflow area in both flow directions. It is understood that such a valve arrangement can be splitted into two control valve members which are actuated by separate differential pistons, with each valve member being additionally subject to the compensation pressure of the additional pressure source.

As already mentioned in one-tube shock absorbers it is appropriate to restrict both flow paths for the compression and the pulling operation according to the invention. In a two-tube shock absorber both throughflow directions must be provided in the piston and also in the bottom valve as well. Therefore, it is conceivable for example to design a bottom valve for the compression operation in a manner according to the invention and to provide a check valve or a blocking valve for the pulling operation which opens in the pulling cycle. In this case the bottom valve is designed in compliance with the invention while for the compression cycle a conventional check valve or blocking valve is provided which opens in the compression cycle. It is further possible to provide an acceleration depending restriction of the throughflow area and a piston for the damping in the two-tube shock absorber while the bottom valve is provided as conventional valve e.g. a disc valve which adjusts the throughflow area in response to the pressure difference of the piston chamber and the storage volume of the annular chamber. Finally it is conceivable with two-tube shock absorbers to design the piston valve and the bottom valve in a manner according to the invention for the compression and the pulling cycle as well and to divide the damping effect for both directions on both valves. For example such a division can be carried out in a relation of 80 to 20 with the larger damping effect takes place in the piston valve. In such an arrangement a backflow in the piston valve with a small resistance or in the bottom valve, respectively, cannot be achieved.

Finally, it is conceivable to divide the restricted fluid flow in the piston valve and to lead the flow through separated valves before the medium is again unified. This can be achieved by control valves wherein a differential pressure of the piston chamber and the annular chamber is applied to. Furthermore, a differential pressure of the piston chamber and the additional compensation pressure source is applied to the valve members. Such a division has the advantage that the valve members can be designed smaller and therefore easily accommodated in the damper piston.

The flow area of the fluidic resistance according to an embodiment of the invention is changeable. This change for example can be controlled in response to the damper arrangement i.e. whether it is in the compression or the pulling cycle. In the pulling cycle another dampening is required than in the compression cycle. It is also conceivable to control the throughflow area in response to the steering angle and/or to the actuation of the braking pedal in a vehicle.

A change of the throughflow area can for example be carried out by means of a solenoid valve which preferably is parallel connected to a constant restriction. A solenoid valve, however, requires an electrical cable which must be led into the interior of the piston cylinder arrangement of the shock absorber.

### BRIEF DESCRIPTION OF THE DRAWINGS

Embodiment examples of the invention are subsequently described along the drawings, wherein

FIG. 1 shows diagrammatically a circuit for a piston valve according to the invention.

FIG. 2 shows another embodiment of the piston valve according to the invention only for one flow direction.

FIG. 2a shows an alternative embodiment with respect to FIG. 2.

FIG. 3 shows diagrammatically a circuit for a bottom valve according to the invention.

FIG. 4 shows another embodiment for a bottom valve according to the invention for only one flow direction.

FIG. 5 shows an acceleration proportional displacement of a valve with a differential piston for a piston valve.

FIG. 6 shows extremely diagrammatical the division of a differential piston into two separate smooth pistons.

FIG. 7 shows diagrammatically the combination of a hydraulic resistance and a hydraulic capacitance for valves of FIG. 1-4.

FIG. 8 shows a conflict diagram of two characteristic curves for a shock absorber.

FIG. 9 shows a cross section of a two-tube shock absorber with a valve arrangement according to the invention.

FIG. 10 shows a circuit according to the invention for a two-tube shock absorber.

### DETAILED DESCRIPTION OF THE DRAWINGS

All described embodiments show a hydraulic application. The invention is not restricted thereto.

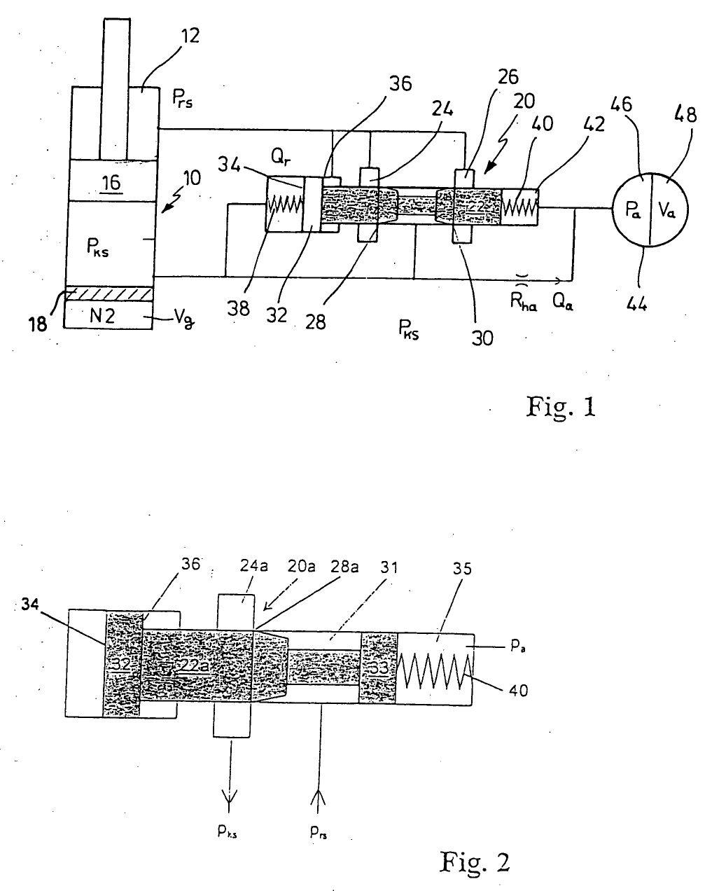

FIG. 1 shows diagrammatically a one-tube shock absorber 10 having an annular chamber 12 and a piston chamber 14 which chambers are separated by a piston 16. A freely floatable piston 18 separates the piston chamber 14 from a storage volume Vg which is filled for example with nitrogene under a predetermined pressure. Such an arrangement is generally known. In FIG. 1 further a two-way-valve 10 can be recognized having an integral valve spool or member 22. Two spaced annular grooves 24, 26 of the valve housing not shown are continuously connected with the annular chamber 12. Control edges 28, 30 of the valve member 22 co-act with the grooves 24, 26. In the constricted portion of the valve spool 20 a connection to the piston chamber 14 is established. A control piston 32—which is a differential piston—is connected to valve spool 22. Its larger effective surface 34 is subject to the pressure of the piston chamber 14. A smaller effective surface 36 is subject to the pressure of the annular chamber 12. A spring 38 acts on control piston 32, and a spring 40 acts on the right end of the valve spool. The springs 38, 40 are designed such that the valve spool is in the shown neutral position upon static balance at the shock absorber 10.

A pressure compensating or balancing volume 44 is connected to the right valve chamber 42 of the two-way-valve 20. A first storage chamber 46 is separated from the second storage chamber 48 through a diaphragm. In the latter, a gas volume is enclosed under pressure. The storage chamber 46 is connected to the valve chamber 42 and acts on the right end surface of valve spool 22. The piston chamber 14 is connected to the conduit between the storage volume 46 and the valve chamber 42, i.e. through a hydraulic resistance Rₕₐ. This hydraulic resistance together with the compensation storage 44 which defines a hydraulic capacitance, forms a hydraulic filter member.

The damper spring which usually is parallel to the shock absorber is not shown.

In the pressure cycle the piston chamber 14 is set under pressure. A differential pressure is established at the differential piston forming the control piston which displaces the valve spool 22 to the right so that medium from piston chamber 14 may flow into groove 26 and from there into the annular chamber 12. Since the displaced volume is larger than that which can be accommodated by annular chamber 12 an enlargement of the volume of the piston chamber results in an enlargement of the storage volume V_{g}.

A displacement of valve spool 22 does not only act against the pressure in annular chamber 12, rather the pressure which is built up in the compensation storage which is depending upon the pressure in piston chamber 14. The effective surfaces 34, 36 of control piston 32 and the right effective surface of valve spool 22 in conjunction with the hydraulic filter member are dimensioned such that the spring force of the not shown absorber spring and the damping force of the shock observer 10 as well are considered. Therefore, it is possible to adjust the throughflow area of the described piston valve in response to the acceleration of the mass and thus to vary the damping effect in dependence of the acceleration of the mass. For the pulling cycle a displacement of the valve spool 22 to the left occurs so that the medium enters the piston chamber through groove 24 and the control chamber 28.

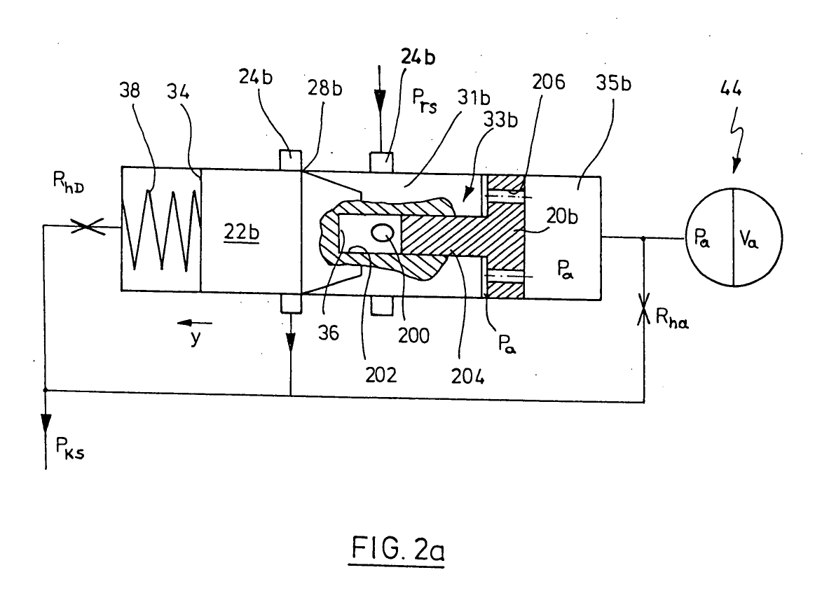

In FIG. 2 a piston valve 20a is illustrated which has similar components as piston valve 20 of FIG. 1. Therefore, equal parts are provided with equal reference numbers.

A valve member or valve spool 22a has only one control edge 28a which co-acts with the groove 24a. Groove 24a is connected to the piston chamber of the not shown shock absorber which can be formed similar to shock absorber 20 of FIG. 1. A valve chamber 31 is connected to the annular chamber of the shock absorber. A piston 33 connected to valve spool 22a seals valve chamber 35 to the right. The valve spool is subject to the force of a spring 40, and chamber 35 is in the same manner connected to a storage volume as shown in FIG. 1. Such a piston valve 20a can be used to achieve an acceleration dependent damping in one flow direction of the absorber. In the other direction a conventional valve can be used. Valve 20a can be provided twice in that the valve of FIG. 1 is divided into two valves each of which being actuated in the manner described. Upon a displacement of the shock absorber contrary to the illustration of FIG. 2 e.g. in the compression cycle the corresponding valve member 22a should be displaced in the opposite direction, in order to provide a throughflow area.

In the embodiment of FIG. 2a a control edge 28b of valve spool 22b cooperates with a groove 24b. Groove 24b is connected with the piston chamber of the not shown shock absorber of FIG. 1. The control spool 22b has the effective surface 34 (see FIGS. 1 and 2), which faces a portion of a through-going bore of the same diameter and wherein a spring 38 is located. A further piston portion 33b of spool 22b has an effective surface which faces bore portion 35b which is connected with a pressure source 44. Furthermore, it is in communication with the piston chamber of the shock absorber 10 of FIG. 1 through a hydraulic resistance Rₕₐ. A valve chamber 31b between the piston portions of spool 22b is in communication with an annular groove 24b which is connected to the annular chamber of shock observer 10 in FIG. 1. The valve chamber 31b is connected with a central, internal axial bore 202 through bores, one of which being shown at 200. A piston portion 204 is located in bore 202 which seals the bore portion to the right. By this, an oppositely directed second effective surface 36 is provided. The piston portion 204 is connected to a cylindrical disc 206 which is fixedly fastened in the bore portion. It has a plurality of axial parallel through bores 206 so that the pressure Pₐ may act on the right effective surface of piston portion 33b.

The piston arrangement of FIG. 2a also serves as differential control piston. It is smooth in the bore and easily to manufacture. The valve spool 22b acts as dampening means in the pulling direction of the not shown shock absorber and the medium in annular chamber 22 flows into piston chamber 14 through the restriction edge 28b. Moreover, the function is the same as described along FIGS. 1 and 2.

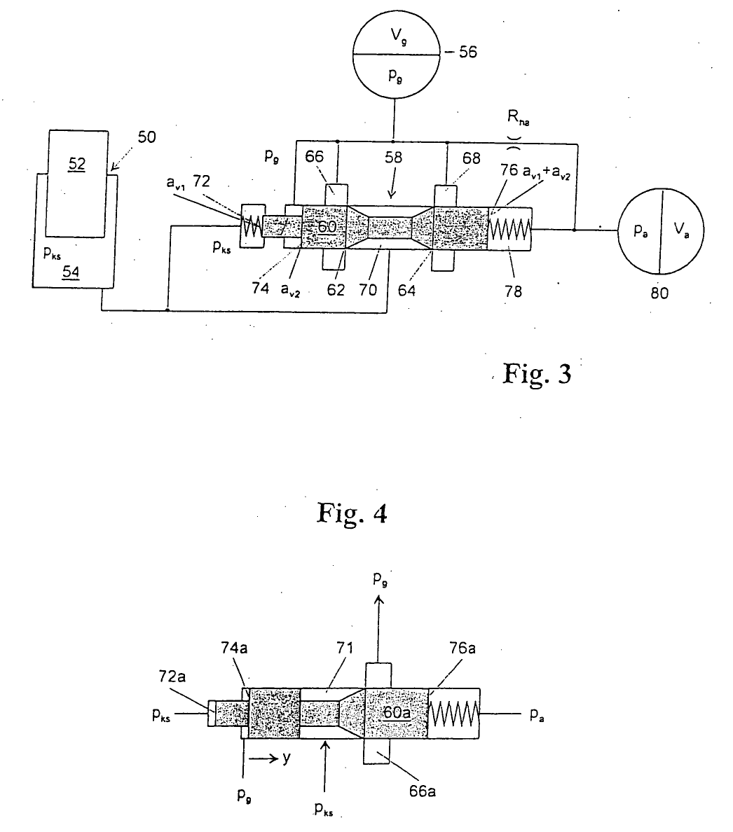

In FIG. 3 a plunger cylinder shock absorber arrangement 50 is diagrammatically illustrated. It has a plunger 52 and a cylinder 54. Upon actuation of this arrangement in compression direction the medium in cylinder 44 is urged into an external storage 56, i.e. through a bottom valve 58 which is to be described hereinafter.

The bottom valve has a valve spool 60 provided with two control edges 62, 64 which co-act with annular grooves 66, 68. The annular grooves 66, 68 are connected to a storage 56 which is known as a storage volume V_{g} under pressure P_{g}. In the storage volume V_{g} a storage gas is included under a predetermined pressure. The pressure P_{g} changes in response to the performance of the shock absorber. The valve chamber 70 between the control edges 62, 64 which is defined by a restriction of valve spool 60 is connected to the cylinder chamber 54.

A control piston arrangement results from a first piston portion 72 the effective surface thereof being subject to the pressure in cylinder chamber 54. A second effective surface 74 which is formed by the difference between piston portion 72 and the left valve spool portion is subject to pressure P_{g} of the storage volume V_{g}. A third effective surface 76 which faces the right valve chamber 78 is subject to the pressure of the pressure balancing storage 80 which has a storage volume Vₐ and a storage pressure Pₐ, the storage volume Vₐ being filled with gas under a predetermined pressure, and the volume is in communication with the storage volume V_{g}, that is through a hydraulic resistance Rₕₐ. The valve spool 60 on opposite sides is loaded by springs which hold valve spool 60 in the shown neutral position.

If plunger 52 is moved into cylinder chamber 54, the pressure in cylinder chamber 54 is increased, and a displacement of valve spool to the right takes place so that the medium can flow from cylinder chamber 54 into storage 56. The amount of the displacement of valve spool 60 and thus the throughflow area depends on the pressures acting on effective surfaces 72, 74, 76. The effective surfaces are dimensioned such that a dependency of the throughflow area from the mass acceleration is achieved. In the opposite or pulling operation the pressure in storage 56 acts on effective surface 74 and effective surface 76 so that the damper medium can flow back into the cylindrical chamber 54.

Also in this case an acceleration responsive adjustment of the throughflow area in both flow directions is achieved.

It is understood that in spite of plunger cylinder as shown in FIG. 3 also a piston can be provided which cooperates with piston chamber 54 while the annular chamber is connected to atmosphere. Finally the two-way-valve 54 illustrated in FIG. 3 can be used for a bottom valve in a two-tube shock absorber which however is not shown or outlined in detail since the way of function is not different. However, in a bottom valve for a two-tube shock absorber it can be provided that only in the compression cycle an acceleration dependent change of the throughflow area can be achieved while in the pulling operation or cycle a valve arrangement in the piston works in a manner already described and which effects also an adjustment of the throughflow area in dependence of the mass acceleration. Finally, as also mentioned it is conceivable to allow a damping in the piston and the bottom valve as well either in the pulling and the compression operation or cycle and to provide a change of the throughflow area as outlined in connection with FIGS. 1-3.

It is also possible to divide the integral valve spool 60 into two valve spools, one of which being shown in FIG. 4 at 60a. Valve spool 60a is actuated by a control piston which has a first effective surface 72a and a second effective surface 74a which act in the same direction. The first effective surface 72a is subject to the pressure Pₖₛ of cylindrical chamber 54 according to FIG. 3. The second effective surface 74a is subject to pressure P_{g} of storage 56 of FIG. 3. The annular groove 66a is also connected to storage 56, and the valve chamber 71 which is formed in a constriction of valve spool 60a and the control piston is connected to the cylinder chamber 54. The right effective surface 76a of valve spool 60a is subject to pressure Pₐ of compensation storage 80 of FIG. 3. In this manner an acceleration depending adjustment of the throughflow area takes place in the bottom valve for one flow direction. Thus, the valve arrangement of FIG. 3 is divided into two arrangements with in each flow direction a damping takes place in the manner according to the invention. It is also conceivable to use the valve arrangement of FIG. 4 solely for a bottom valve in a two-tube shock absorber while for the other flow direction e.g. a check valve is provided. In this case for the other actuation direction a restriction of the damping medium in the piston of the two-tube shock absorber is necessary e.g. with the valve of FIG. 1 or 2 for one or both flow directions with a blocking or check valve for the flow directions.

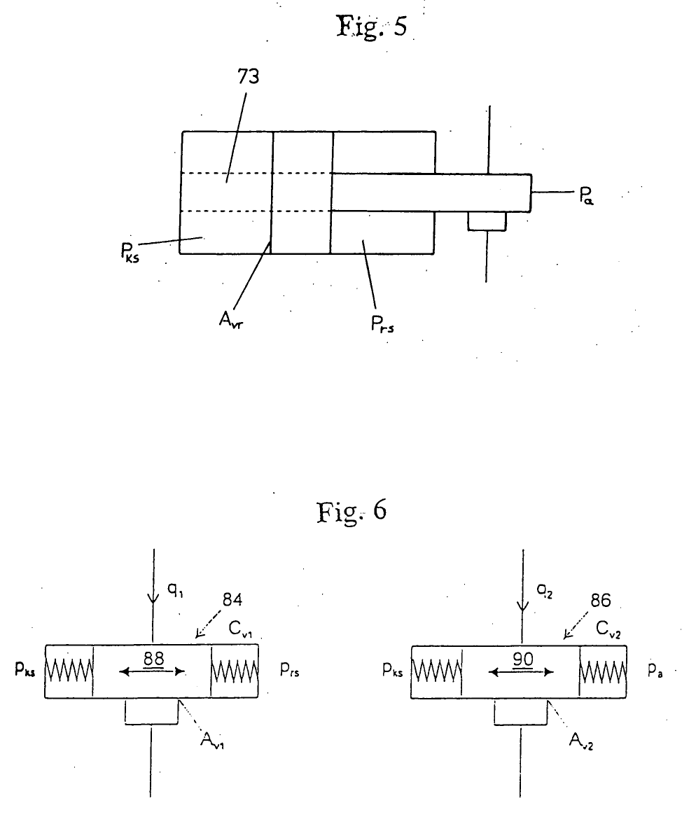

In FIG. 5 it is to be diagrammatically indicated that a dampening in a piston valve can take place in both displacement directions in response to the displacement travel by means of a differential piston according to the principle shown in FIGS. 1 and 2. As described above, the amount of displacement is depending upon the mass acceleration. By dashed line 73 in FIG. 5 it is to be indicated that in spite of a differential piston as shown for example in FIG. 1 to smooth pistons can be used as shown in FIG. 6. This is also valid for the actuation of the bottom valve.

In FIG. 6 it is extremely diagrammatically indicated how the flows e.g. through a piston valve can be divided for the displacement of the absorber piston. The division takes place through two flow paths with the rate of flows q1 and q2 which are led through valve 44 and 46, respectively having valve spools 88, 90 with valve spool 88 on one side is subject to pressure Pₖₛ and on the other side to pressure Pᵣₛ i.e. to the pressure difference at the absorber piston. The throughflow area Aᵥ₁ varies in response to the displacement of valve spool 88. Valve spool 90 of valve 86 is subject to pressure Pₛ and to pressure Pₐ on opposite sides. Pₖₛ is the pressure in the piston chamber and Pₐ the balancing pressure for example of storage 44 in FIG. 1. The throughflow area Aᵥ₂ is the result of the difference of the pressures applied to valve spool 90. The dimensioning of valve 86 is such that the function of the spring carbody is represented. The valve arrangement as indicated in FIG. 6 has inter alia the advantage to be very small and thus can be easily accommodated in the shock absorber piston. If valve spool 90 is blocked, the valve arrangement works similar to conventional shock absorbers.

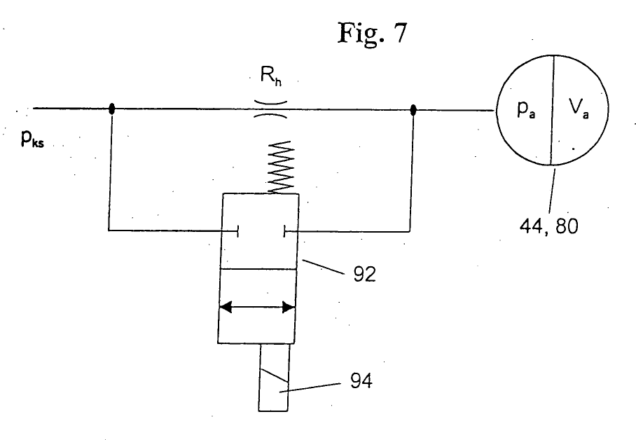

In FIG. 7 a balancing or compensation pressure storage 44 or 80, respectively of FIG. 1 or 3 is illustrated. It is connected with the piston chamber of a shock absorber in a cylinder piston arrangement or a cylinder chamber 54 of FIG. 3 through an orifice Rₕ of constant flow area. A controllable check valve 92 is connected parallel to orifice Rₕ which is controlled by a solenoid 94. More or less damper medium flows through the check valve 92 in response to the control of the solenoid 94 and thus changes the hydraulic resistance which is formed by the parallel connection of orifice Rₕ and valve 92. The control signal for the solenoid can be formed in dependence from different parameters, e.g. in dependence from the fact whether the absorber is operated in a pulling operation or in a compression operation or also in dependence of a steering angle and/or the actuation of a braking pedal in the vehicle which is equipped with the shock absorber.

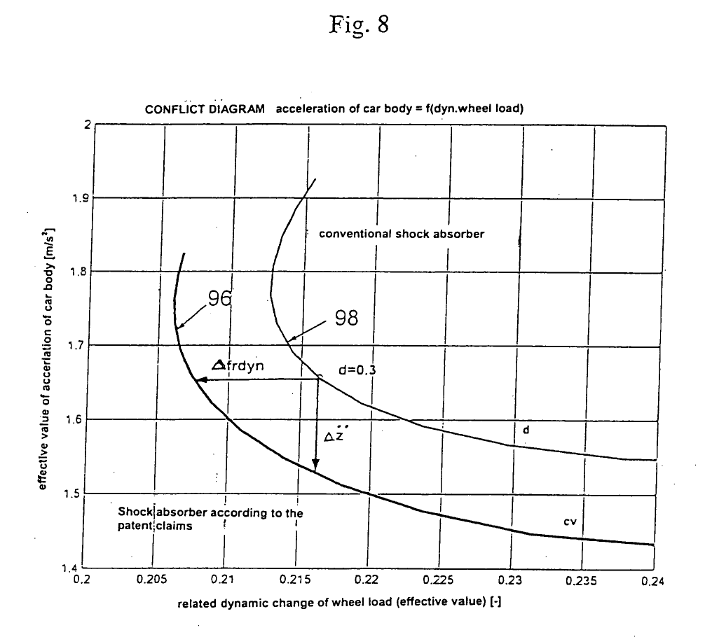

In FIG. 8 two shock absorber curves 96, 98 of a so-called conflict diagram can be seen. They represent the behaviour of the shock absorber, with the mass acceleration as shown in dependence of the variation of the wheel load. The curve 98 is one for a conventional shock absorber while curve 96 shows the behaviour of a shock absorber which is provided with the bottom valve and/or a piston valve according to the invention. It can be seen that the working point for the design of the shock absorber according to the invention is significantly lower than in the prior art. This means that with equal dynamic wheel loads a gain for the comfort is achieved. Upon equal comfort and equal safety a reduction of dynamic wheel loads is achieved. Finally, an enlargement of the spring constant for the body springs can be achieved with equal comfort and safety. Finally, an improved longitudinal and transverse dynamic property is possible. These properties as mentioned above can be achieved with small control masses and thus with high natural frequency.

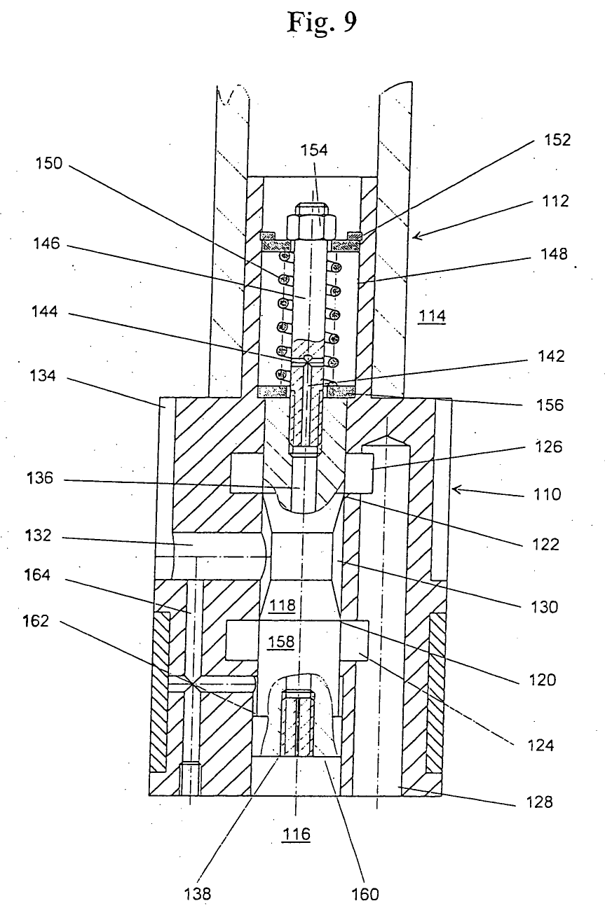

In FIG. 9 an example for an embodiment for a valve in a damper piston is shown.

A damper piston 110 of an incompletely illustrated shock absorber is contained in a not shown cylindrical tube. The absorber can be a one-tube or a two-tube shock absorber. Piston 110 is connected with a piston rod 112. Thus, an annular chamber 114 is formed and below piston 110 a piston chamber 116 is located. The selective connection between piston chamber 116 and annular chamber 114 takes place by a valve spool 118 which is displaceably supported in an axial bore in piston 110. Control edges 120 and 122 of ring spool 118 co-act with edges of grooves 124, 126. The grooves 126, 126 are in communication with at least one axial parallel passage 128 which is continuously in connection with piston chamber 116. The above chamber 130 which is formed by a constriction of valve spool 118 is in continuous communication with annular chamber 114 through a transverse bore 132 and an axial parallel longitudinal recess 134.

Valve spool 118 has an axial throughbore 136 wherein a restriction is located by means of an insert 138. A rod 140 is threaded into the upper end of the throughbore 136 which has an axial blind bore 142 which in turn is connected with a volume 148 in the piston rod 122 through radial bores. The volume is portion of a not shown pressure storage VₐPₐ. A spring 150 is supported by the piston through an annular spring 152 and a nut 154 on rod 140, respectively, and on a disc 156 on valve spool 160 on the other side.

A differential piston 158 is connected with valve spool 118 which has a first effective surface 160 and an oppositely directed effective surface 162. Effective surface 160 is continuously subject to the pressure in piston chamber 116, and the effective surface 162 is continuously connected with annular chamber 114 through bores 164. Thus, the difference of the pressures of annular chamber 114 and piston chamber continuously acts on the differential piston 158. The pressure of storage 158 also acts on valve spool 114 in that the right end surface of the valve spool 118 is subjected. Thus, the structure showing in detail corresponds to that which is diagrammatically shown in FIG. 1.

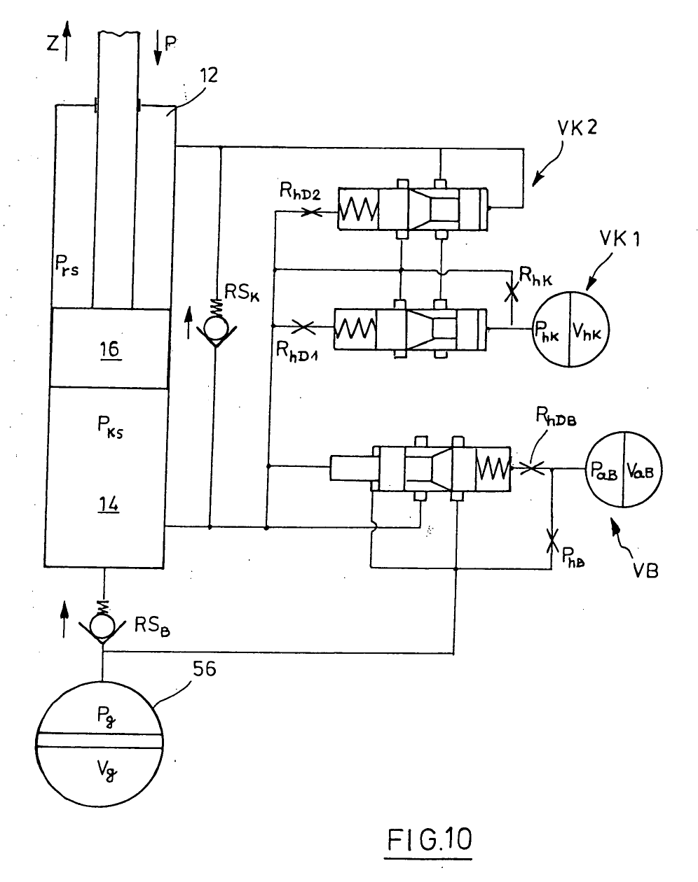

The function of the invention is to be illustrated along FIG. 10 for a two-tube shock absorber. The outer tube is not shown, rather substituted by storage 56 which is shown in FIG. 3. The storage is connected to piston chamber 14 through check valve RS_{B}. The piston chamber is also connected to annular chamber 12 through a check valve RS_{K}. A first piston VK1 and a second piston valve VK2 are parallel connected. The function of the piston valves VK1 and VK2 correspond to that described in connection with FIGS. 5 and 6. The differential pressure between annular chamber 12 and piston chamber 14 acts on the piston arrangement of piston valve VK2. This represents the dampening force. The piston arrangement of the piston valve VK1 represents the spring force. This has been described above. The bottom valve V_{B} in FIG. 10 resembles valve arrangement of FIG. 4 with respect to its structure. The right effective surface is subject to the compensation pressure P_{aB} while the right effective surface of the control piston arrangement of piston valve VK1 is subject to compensation pressure Pₐₖ. The left effective surface of piston valves VK1 and VK2 is in communication with the piston chamber 14 through orifices R_{hD1} and R_{hD2}. The compensation or balancing pressure P_{aB} is connected through orifice R_{hDB}.

The balancing volume V_{g} and the pressure source P_{g} can be placed in the annular space between the outer and the inner tube of the incompletely shown shock absorber. The bottom valve arrangement consists of a check valve RS_{B} and a bottom valve V_{B}, and the piston valve arrangement consists of a check valve RS_{K} and both piston valves VK1 and VK2.

In the following the function of the arrangement of FIG. 10 is to be described. First the compression cycle or operation is outlined. The medium can flow from piston chamber 14 into annular chamber 12 through RS_{K} with low resistance. The pressures Pₖₛ and Pᵣₛ are substantially equal. The piston cylinder structure can be a plunger cylinder. The absorption or damping takes place only in bottom valve VB.

In the pulling step or cycle or operation Z the fluid can be flow from storage 56 into piston chamber through check valve RS_{B} nearly without losses. The pressures P_{g} and Pₖₛ are substantially equal. The piston cylinder arrangement acts as differential cylinder while the pulling absorption takes place in the piston valves VK1 and VK2. The fluid flowing through VK1 is a rate for the spring force, and the fluid flowing through VK2 is a rate for the absorption force. Dimensions, valve springs and flow areas have to be dimensioned with respect to each other.

The arrangement of FIG. 10 has the advantage that valves RS_{B}, RS_{K} and FK2 can be manufactured as known spring disc valves, and the piston valve VK1 with the balancing volume can be located in the interior of the hollow piston rod as already described in connection with FIG. 9.

The piston valves VK1 and VK2 can be substituted by a valve arrangement as shown in FIG. 2 and also described.

For the dampening of the movement of the control piston of the piston valves VK1 and VK2 and V_{B} as already mentioned the flow resistances R_{hD1}, R_{hD2} and R_{hB} are provided which can be formed as simple orifices. The flow resistances R_{hD1} and/or R_{hB} can be variable as already described above.

Finally it is conceivable to divide bottom valve V_{B} into two single valves which is mentioned in connection with FIG. 3.

1. A controllable piston valve for a shock absorber having a piston cylinder structure, the piston valve comprising:
a first piston valve member which controls a throughflow area; a control piston defined as a differential piston that includes oppositely directed effective surfaces subject to the pressure of a piston and an annular chamber respectively, of the piston cylinder structure,
wherein the control piston and/or the valve member is additionally loaded with the pressure Pₐ of a pressure source opposite to the larger of the effective surfaces, the pressure source being formed of a combination of a fluidic resistance Rₕₐ and a fluidic capacitance and is supplied by the pressure in the piston or annular chamber respectively, of the piston cylinder structure.

2. A controllable piston valve for a shock absorber having a piston cylinder structure, the piston valve comprising:
a first and a second piston valve member, each valve member controlling a throughflow area and each being actuable by two control piston portions, wherein effective surfaces of the control piston portions of the first piston valve member are connected to the piston and the annular chamber of the piston cylinder structure and effective surfaces of the control piston portions of the second piston valve member are connected with the piston chamber or a pressure source, the pressure source being formed by the combination of a fluidic resistance Rₕₐ and a fluidic capacitance which is supplied by the pressure of the piston or the annular chamber respectively of the piston cylinder structure.

3. The piston valve of claim 1, wherein a second piston valve member is located parallel to the first piston valve member which is also actuated by a control piston being a differential piston, the opposite effective surfaces thereof being subject to the pressure of the piston chamber and the annular chamber of the piston cylinder structure.

4. The piston valve of claim 1, wherein said valve is formed as a two-way-valve having an integral piston valve spool with two control surfaces or edges respectively, the valve spool being actuated by the control piston and the pressure Pₐ of the balancing pressure source.

5. A controllable bottom valve for a shock absorber having a piston cylinder structure or a plunger cylinder structure with a storage volume, respectively, the bottom valve comprising:
a first bottom valve member which controls a throughflow area and is actuated by a control piston defined by a differential piston,
the control piston having a first effective surface which is subject to the pressure in the piston or plunger chamber of the piston or plunger cylinder structure,
the differential piston having a second effective surface which is subject to the pressure of the storage volume, the effective surfaces being oppositely directed, and in which
the pressure Pa of the pressure source acts on the bottom valve or the control piston, respectively opposite to the effective surfaces, the pressure source including a combination of a fluidic resistance Rₕₐ and a fluidic capacitance and being supplied by the pressure of the piston chamber or the plunger chamber, respectively, or the pressure of the storage volume.

6. The bottom valve of claim 5, wherein a second bottom valve member is arranged parallel to the first bottom valve member, the second valve member being actuated by a differential piston having effective surfaces facing in the same direction and being subject to the pressure of the piston or plunger chamber, respectively, and the storage volume.

7. The bottom valve of claim 5, wherein it is formed as a two-way-valve having an integral valve spool with two control surfaces or edges, respectively, the valve spool being actuated by the control piston or the pressure source.

8. The valve of claim 1, wherein the effective area of the fluidic resistance is variable.

9. The valve of claim 8, wherein the flow area is changed in dependence of the compression or pulling performance of the shock absorber.

10. The valve of claim 8, wherein the flow area is changed in dependence of the steering angle and/or the actuation of a brake pedal of a vehicle.

11. The bottom valve of claim 1, wherein the fluidic resistance includes a solenoid valve.

12. The valve of claim 11, wherein the solenoid valve is connected in parallel to an orifice Rₕₐ of constant area.

13. A valve of claim 5, said valve being applied to a two-tube shock absorber.

14. The valve of claim 1, wherein the piston valve spool is displaceably supported in an absorber piston and held in a neutral position by a spring arrangement, and a passage through a valve spool with a restriction forms the fluidic resistance which is in communication with a storage volume in piston rod.

15. Controllable piston valve of claim 1, wherein control piston and piston valve are formed at an integrally formed piston arrangement which is located in a bore of same diameter, a piston portion controlling a first throughflow area has a first effective surface, an oppositely directed second effective surface is formed at a piston portion which is loaded with pressure Pₐ of the pressure source, a valve chamber formed through an outer constriction of the valve spool is connected to the annular chamber of the piston cylinder structure and is in communication with an inner bore through at least one radial bore in the piston arrangement, and a piston portion extends into the inner bore which is fixedly attached to the bore and subject to the pressure of the pressure source.

16. The valve of claim 5, wherein the piston valve spool is displaceably supported in an absorber piston and held in a neutral position by a spring arrangement, and a passage through a valve spool with a restriction forms the fluidic resistance which is in communication with a storage volume in piston rod.

17. Controllable piston valve of claim 5, wherein control piston and piston valve are formed at an integrally formed piston arrangement which is located in a bore of same diameter, a piston portion controlling a first throughflow area has a first effective surface, an oppositely directed second effective surface is formed at a piston portion which is loaded with pressure Pₐ of the pressure source, a valve chamber formed through an outer constriction of the valve spool is connected to the annular chamber of the piston cylinder structure and is in communication with an inner bore through at least one radial bore in the piston arrangement, and a piston portion extends into the inner bore which is fixedly attached to the bore and subject to the pressure of the pressure source.
